(19) United States
(12) Patent Application Publication
(10) Pub. No.: US 2004/0243345 A1
(43) Pub. Date: Dec. 2, 2004

(54) Tester and testing method

(75) Inventors: Tatsuhisa Fujii, Hiroshima (JP); Kazuhiro Monden, Hiroshima (JP); Mikiya Kasai, Hiroshima (JP); Shogo Ishioka, Hiroshima (JP); Shuji Yamaoka, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHT Inc., Hiroshima (JP)

(21) Appl. No.: 10/490,292

(22) PCT Filed: Sep. 18, 2002
(86) PCT No.: PCT/JP02/09545

(30) Foreign Application Priority Data
Sep. 20, 2001 (JP) 2001-287637

(51) Int. Cl. G06F 15/00

(52) U.S. Cl. 702/182

(57) ABSTRACT

Disclosed is an apparatus and method for inspection a circuit wiring on a circuit board. In advance of an actual inspection of the circuit board, image data on all of standard circuit wirings of a standard circuit board are extracted and registered as standard-shape or reference data (FIG. 14). An actual-image data obtained by actually inspecting a target circuit wiring is compared with the reference data through a least squares method (S 167) to determine the state of the target circuit wiring in accordance with a correlation value of the two data (S168). The comparison result is displayed on a display 21a while specifying a region from the reference data (S169).

### TECHNICAL FIELD

The present invention relates to a circuit-wiring inspecting apparatus and method for inspecting a circuit wiring.

### BACKGROUND ART

In manufacturing processes of a circuit board, it is required to inspect the presence of disconnection and/or short-circuit in circuit wirings formed on a circuit board.

The recent progressive densification of circuit wirings causes difficulties in assuring a sufficient space for simultaneously arranging a plurality of inspection pins at both ends of individual circuit wirings and bringing the tips of the inspection pins into contact with the corresponding ends of the circuit wirings during the operation of inspecting circuit wirings. In view of such circumstances, there has been proposed a non-contact type inspection technique allowing electric signals from circuit wirings to be received without any contact with both ends of the circuit wirings (see Japanese Patent Laid-Open Publication No. Hei 9-264919).

As is shown in FIG. 21, this non-contact type inspection technique comprises bringing an inspection pin into contact with one of the ends of a specific circuit wiring to be inspected (hereinafter referred to as “target circuit wiring”), placing a sensor conductor at the other end of the target circuit wiring in non-contact manner, supplying an inspection signal from the inspection pin to change the potential of the target circuit wiring, and detecting the potential variation using the sensor conductor to inspect the presence of disconnection or the like in the target circuit wiring.

The above conventional non-contact type inspection technique is intended to simply detect whether a circuit wiring exists at a certain position (a portion of the circuit wiring located at the certain position has a potential variation). Thus, it is difficult to readily evaluate the state of the entire circuit wiring between both ends thereof, or an operator can not intuitively evaluate the state of the entire circuit wiring.

### DISCLOSURE OF THE INVENTION

In view of the above problems, it is an object of the present invention to provide a circuit-wiring inspecting apparatus and method capable of solving the above problems, for example, allowing an operator to evaluate the state of a circuit wiring in a simple control readily and intuitively.

In order to achieve the above object, according to a first aspect of the present invention, there is provided an inspection apparatus for inspecting selected at least one of a plurality of circuit wirings formed on a circuit board, which comprises supply means for supplying an inspection signal to the selected circuit wiring, detecting means including a plurality of sensor elements to detect potential variation generated in the selected circuit wiring in response to the inspection signal, standard-pattern registration means for creating standard-image data representing the shape of a standard circuit wiring formed on a standard circuit board, in accordance with positional information from one or more of the sensor elements which have detected potential variation generated in the standard circuit wiring in response to the inspection signal supplied from the supply means to the standard circuit wiring, and then registering the created standard-image data therein, actual-image data creation means for creating actual-image data representing the shape of the selected circuit wiring, in accordance with positional information from the sensor elements which have detected potential variation generated in the selected circuit wiring in response to the inspection signal supplied from the supply means to the selected circuit wiring, and inspection means for comparting between the actual-image data created by the actual-image creation means and the corresponding standard-image data registered in the standard-image registration means, to inspect the selected circuit wiring.

In the inspection apparatus set forth in the first aspect of the present invention, the standard-pattern registration means may be operable to create and register the standard-image data representing the entire shape of the standard circuit wiring, and the inspection means may be operable to specify a certain region of the circuit wiring to be supplied with the inspection signal, in accordance with design data on the shape of the circuit wiring and compare the standard-image data corresponding to the specified region with the actual-image data obtained from the specified region of the circuit wiring.

The supply means may be operable to supply the inspection signal to each of the circuit wirings at a different timing.

The sensor elements may be formed in a matrix arrangement having a plurality of horizontal sensor-element lines each including two or more of the sensor elements. In this case, the supply means may be operable to supply a selection signal simultaneously to all of the sensor elements in one of the sensor-element lines, and the detecting means may be operable to simultaneously detect potential variation in the circuit wiring opposed to the sensor-element line.

According to a second aspect of the present invention, there is provided a method for inspecting selected at least one of a plurality of circuit wirings formed on a circuit board, which comprises the steps of (a) providing supply means for supplying an inspection signal to the selected circuit wiring, detecting means including a plurality of sensor elements to detect potential variation generated in the selected circuit wiring in response to the inspection signal, (b) creating standard-image data representing the shape of a standard circuit wiring formed on a standard circuit board, in accordance with positional information from one or more of the sensor elements which have detected potential variation generated in the standard circuit wiring in response to the inspection signal supplied from the supply means to the standard circuit wiring, and then registering the created standard-image data, (c) creating actual-image data representing the shape of the selected circuit wiring, in accordance with positional information from the sensor elements which have detected potential variation generated in the selected circuit wiring in response to the inspection signal supplied from the supply means to the selected circuit wiring, and (d) comparting between the created actual-image data and the corresponding registered standard-image data, to inspect the selected circuit wiring.

In the method set forth in the second aspect of the present invention, the standard-image creating step may include creating and registering standard-image data representing the entire shape of the standard circuit wiring, and the comparing step may include specifying a certain region of the circuit wiring to be supplied with the inspection signal, in accordance with design data on the shape of the circuit wiring, and comparing the standard-image data corresponding to the specified region with the actual-image data obtained from the specified region of the circuit wiring.

### BRIEF DESCRIPTION OF THE DRAWINGS

FIG. 1 is a schematic diagram of an inspection system according to a first embodiment of the present invention.

FIG. 2 is a block diagram showing the computer hardware configuration of the inspection system.

FIG. 3 is a block diagram showing the electrical configuration of a sensor chip 1 of the inspection system.

FIG. 4 is an explanatory block diagram of a sensor element of the inspection system.

FIG. 5 is an explanatory model diagram of the principle of current generation in the sensor element caused by potential variation in a circuit wiring.

FIG. 6 is an explanatory model diagram of the principle of current generation in the sensor element due to potential variation in a circuit wiring.

FIG. 7 is a timing chart of one example of input/output timings in case where MOSFET is used as the sensor chip.

FIG. 8 is an explanatory diagram of an operation for inspecting circuit wirings (1) to (3) using 6×6 sensor elements of the inspection system.

FIG. 9 is a timing chart showing voltage supply timings to the circuit wirings in FIG. 8 and the timing of outputting data.

FIG. 10 is an explanatory diagram of a sensor drive sequence in the inspection system, in case where a single circuit board is formed with a plurality of circuit wirings.

FIG. 11 is a timing chart showing one example of voltage supply timings for the sensor drive control in FIG. 10.

FIG. 12 is a table for determining a voltage supply sequence to a plurality of circuit wirings, in the inspection system.

FIG. 13 is a table for determining a voltage supply sequence to a plurality of circuit wirings, in the inspection system.

FIG. 14 is a flow chart showing a processing for extracting reference data from a gold sample in the inspection system.

FIG. 15 is an explanatory flow chart of an inspection control in the inspection system.

FIG. 16 is an explanatory diagram of a voltage supply sequence in an inspection system according to a second embodiment of the present invention, in case where a single circuit board is formed with a plurality of circuit wirings.

FIG. 17 is a timing chart showing one example of the voltage supply timing to the circuit wirings, in the inspection system according to the second embodiment.

FIG. 18 is a diagram showing an output image obtained by applying voltage at the timing in FIG. 17.

FIG. 19 is an explanatory diagram of a drive control of sensor chips in an inspection system according to a third embodiment of the present invention.

FIG. 20 is a timing chart showing the drive timing of the sensor chips and the voltage supply timing to circuit wirings in the inspection system according to the third embodiment.

FIG. 21 is an explanatory diagram of a conventional circuit-board inspection apparatus.

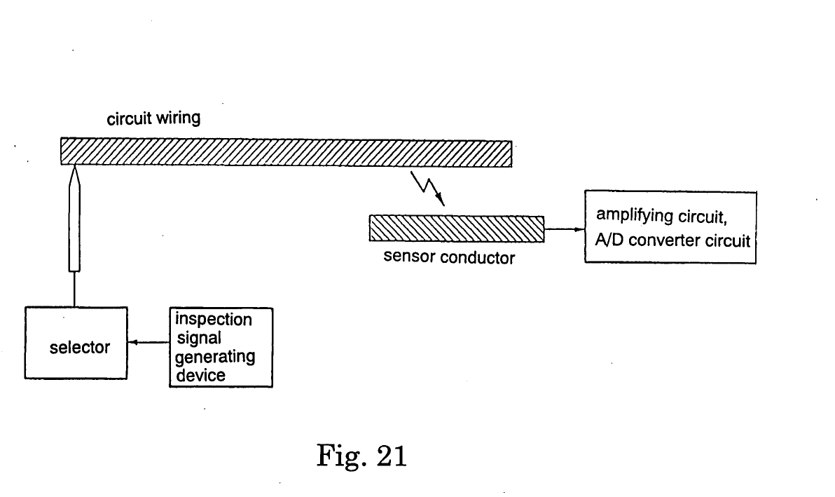

### BEST MODE FOR CARRYING OUT THE INVENTION

With reference to the drawings, an embodiment of the present invention will now be described in detail. The following description is made in connection with an example where the present invention is applied to an inspection system for inspecting a circuit wiring in a circuit board having an integrated circuit chip mounted thereon.

While the following description is made in connection with specific embodiment, the present invention is not limited to any structures, arrangements of components and numerical values of the specific embodiments.

[First Embodiment]

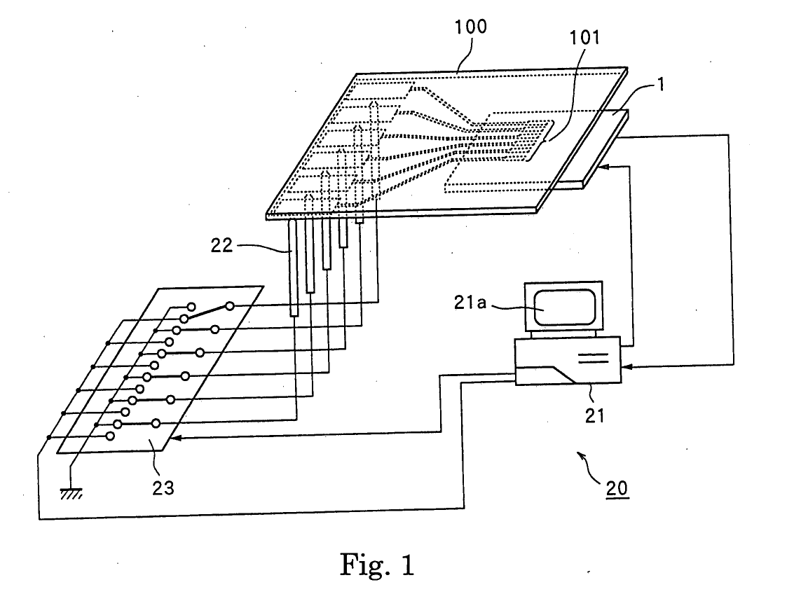

A first embodiment of the present invention will be described in conjunction with an inspection system 20 using a MOSFET as a sensor element. FIG. 1 is a schematic diagram of the inspection system 20 according to the first embodiment.

<Construction of Inspection System>

The inspection system 20 comprises a sensor chip 1 having a plurality of sensor elements, a computer 21, a plurality of probes 22 for supplying an inspection signal to corresponding circuit wirings 101, and a selector 23 for switchingly supply the inspection signal to each of the probes 22. For example, the selector 23 may be composed of a multiplexer or a duplexer.

The computer 21 supplies to the selector 23 a control signal for selecting at least one of the probes 22 and an inspection signal to be supplied to at least one of the circuit wirings 101 to be inspected (hereinafter referred to as “target circuit wiring”). The computer 21 also supplies to the sensor chip 1 a synchronization signal [a vertical synchronization signal (Vsync), a horizontal synchronization signal (Hsync), and a reference signal (Dclk)] for allowing the sensor elements to be operated in synchronous with the control signal supplied to the selector 23.

The inspection signal to be supplied to the circuit wirings may be either one of a voltage pulse and an AC signal. When the voltage pulse is used, the polarity of the signal can be specified, and thereby a related circuit can be designed under the condition that the current direction in the sensor elements is limited to one direction. Thus, the circuit design will be simplified.

When the computer 21 acts to supply an inspection signal to one of the circuit wirings through the probe 22, potential variation is generated in the circuit wiring. The computer 21 receives a detection signal corresponding to the potential variation from the sensor chip 1. Then, the computer 21 creates image data corresponding to a certain region of the circuit wiring where the inspection signal has actually reached, and performs an after-mentioned processing of determining the acceptability of the circuit wiring. Then, the created actual image is displayed on a display 21a of the computer 21 according to need.

This makes it possible to find out the shape of specific one of the circuit wirings and to detect defects, such as disconnection, short circuit or chipping, in the circuit wirings 101 based on the created actual-image data and design-image data corresponding to the design circuit wiring.

Each of the probes 22 has a tip in contact with one of the ends of the circuit wiring 101 on the circuit board 100 to supply an inspection signal to one of the circuit wirings 101.

The selector 23 switchingly selects at least one of the probes 22 to be supplied with an inspection signal. Specifically, the selector 23 performs a switching operation according to a control signal supplied from the computer 21 to allow an inspection signal to be supplied to each of the independent circuit wirings 101 on the circuit board 100 individually.

The selector 23 also performs the switching operation in such a manner that the circuit wirings not to be supplied with an inspection signal (hereinafter referred to as “non-target circuit wiring) are connected to a ground level (GND) or a low impedance line such as a power source. This is done to prevent the sensor elements from receiving an error signal otherwise caused by transferring an inspection signal from a target circuit wiring to non-target circuit wirings due to cross talk.

The sensor chip 1 is disposed at a position opposed to the circuit wirings 101 on the circuit board 100 in a non-contact manner to detect potential variation which is generated in the circuit wiring 101 in response to an inspection signal supplied from the probe 22, and then output the detected potential variation to the computer 21 as a detection signal. The distance between the sensor chip 1 and the circuit wirings may be set at 0.5 mm or less, preferably 0.05 mm or less. The sensor chip 1 may be arranged at a position close to the circuit board while interposing a dielectric insulating material therebetween.

While the circuit wirings 101 of the circuit board 100 in FIG. 1 are formed on only one of the side surfaces of the circuit board 100, the inspection system according to this embodiment can also inspect a circuit board having the circuit wiring 101 formed on both side surfaces thereof. In this case, the inspection operation may be performed by preparing two of the sensor chips 1 and locating them on the upper and lower sides of to sandwich the circuit board therebetween.

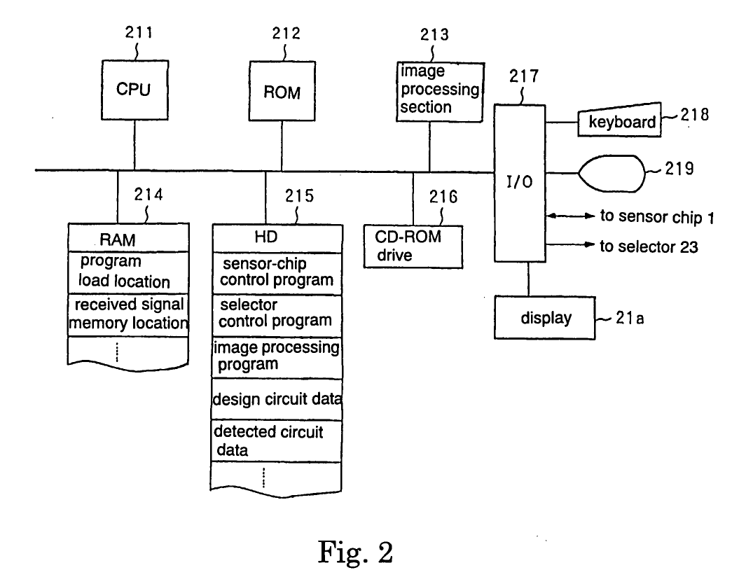

With reference to FIG. 2, the detailed configuration of the computer 21 will be described below. FIG. 2 is a block diagram showing the hardware configuration of the computer 21 in the inspection system.

The reference numeral 211 indicates a CPU for use in various calculations and controls, such as the entire control of the computer 21, and the reference numeral 212 indicates a ROM for storing fixed values and various programs to be executed on the CPU 211. The reference numeral 213 indicates an image-processing section for processing input digital data to create image data and processing the created image data to output on the display 21a, and the reference numeral 214 indicates a RAM serving as a temporary storage device. The RAM 414 includes a program load location for storing programs to be loaded from an after-mentioned HD 215, and a storage location for storing digital signals detected at the sensor chip 1. The digital signals received by the computer 21 are stored with respect to each of sensor-elements groups corresponding to the respective shapes of the circuit wirings.

The reference numeral 215 indicates a hard disk (HD) as an external storage device. The reference numeral 216 indicates a CD-ROM drive as a read device for a detachable recording medium. The reference numeral 217 indicates an input/output interface for interfacing with a keyboard 218 and/or a mouse 219 as an input device, the sensor chip 1 and the selector 23.

The HD 215 stores a sensor-chip control program, a selector control program and an image-processing program. These programs will be loaded on the program load location of the RAM 214, and executed on the CPU.

The HD 215 also stores image data representing the shape of the circuit wiring inspected by the sensor chip 1, and design-image data representing the shape of a corresponding design circuit wiring. Image data from the sensor chip 1 may be stored on the basis of a sensor-element group corresponding to the shape of one of the circuit wirings, or may be stored on the basis of one frame of all of the sensor elements.

More specifically, the HD 215 stores standard-circuit-wiring data including standard-shape data obtained by reading standard circuit wirings formed on a standard circuit board, and actual-shape data obtained by actually inspecting a target circuit wiring, as digital signals detected by the sensor chip 1. In addition to the standard-shape data obtained by reading standard circuit wirings, the standard-circuit-wiring data includes design-image data representing the shape of design circuit wirings. The design-image data is used to specify a certain position or region of the standard circuit wiring and/or a certain position or region of the target circuit wiring.

The sensor-chip control program, the selector control program, the image-processing program and the design-image data representing the shape of the design circuit wirings may be installed by storing them on a CD-ROM or, and reading this CD-ROM record information using the CD-ROM drive, or by storing them on another medium such as FD or DVD, and reading this record information, or by downloading via a networks.

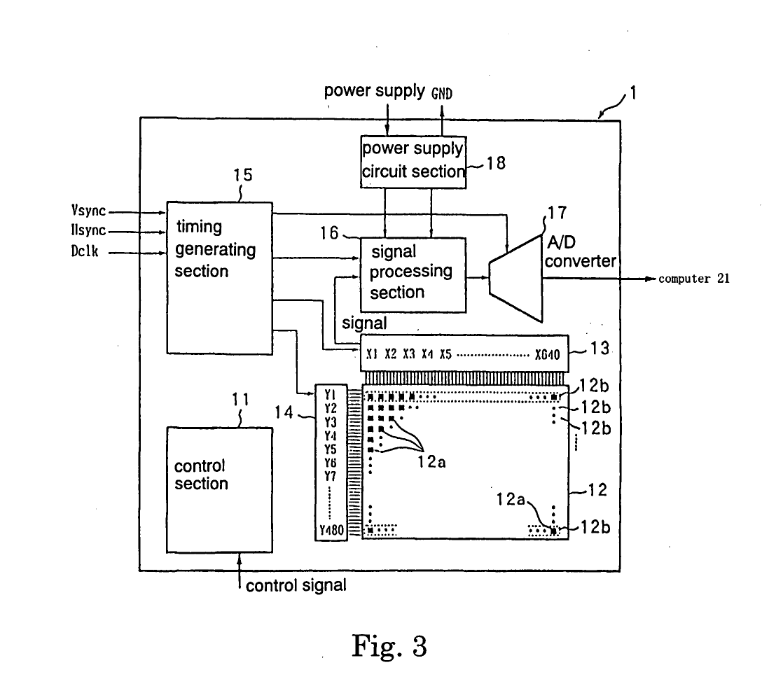

With reference to FIG. 3, the electrical configuration of the sensor chip 1 in the inspection system according to the first embodiment will be described below.

The sensor chip 1 having the electrical configuration as shown in the FIG. 3 is mounted on a package (not shown).

The sensor chip 1 comprises a control section 11, a sensor element set 12 consisting of the plurality of sensor elements 12a composed of an array of thin-film transistors, a vertical select section 14 for selecting at least one of sensor-element lines 12b each composed of a plurality of horizontally aligned sensor elements, a lateral select section 13 for picking up or reading out signals from the sensor elements 12a, a timing generating section 15 for generating a selection signal for selecting at least one of the sensor-element lines 12b, a signal processing section 16 for processing signals from the lateral select section 13, an A/D converter 17 for AID converting signals from the signal processing section 16, and a power supply circuit section 18 for supplying electrical power for driving the sensor chip 1.

The control section 11 is operable to control the operation of the sensor chip 1 in accordance with the control signal from the computer 21. The control section 11 includes a control register for setting the operation timing of the sensor, an amplification factor and a reference voltage.

The sensor elements 12a are formed in a matrix arrangement, and operable to detect in a non-contact manner potential variation generated in each of the circuit wrings 101 in response to an inspection signal supplied from the corresponding probe 22 to the circuit wring 101.

The timing generating section 15 is supplied with the vertical synchronization signal (Vsync), the horizontal synchronization signal (Hsync) and a digital clock signal (Dclk) from the computer 21 to supply a timing signal for selecting specific ones of the sensor elements 12a, to the vertical select section 14, the lateral select section 13, the signal processing section 16 and the A/D converter 17.

The vertical select section 14 selects at least one row of the sensor element set 12 sequentially in accordance with the timing signal from the timing generating section 15. All of the detection signals of the sensor elements 12a in the sensor-element line 12b selected by the vertical select section 14 are output at once from these sensor elements 12a and are input into the lateral select section 13. The lateral select section 13 amplifies the analog detection signals output from 640 pieces of terminals, and then temporarily holds the amplified signals. Then, the lateral select section 13 outputs the analog signals sequentially to the signal processing section 16 in accordance with the timing signal generated by a selecting circuit composed of a multiplexer or the like in the timing generating section 15.

The signal processing section 16 further amplifies the analog signals from the lateral select section 13 to the level required for a determination processing, and performs an analog signal conditioning such as filtering for canceling noise. Then, signal processing section 16 transmits these signals to the A/D converter 17. The signal processing section 16 also includes an automatic gain control to automatically arrange the voltage amplification factor of the signals read from the sensor elements to an optimum value.

The A/D converter 17 converts the detection signals, which are detected by each of the sensor elements and transmitted from the signal processing section 16 in an analog form into the digital signals, for example, of 8-bit, and then outputs these digital signals. The power supply circuit 18 generates a reference clamp voltage for the signal processing section or the like.

While the A/D converter 17 is incorporated into the sensor chip 1 in this embodiment, the analog signals subjected to the analog signal conditioning in the signal processing section may be output directly to the computer 21.

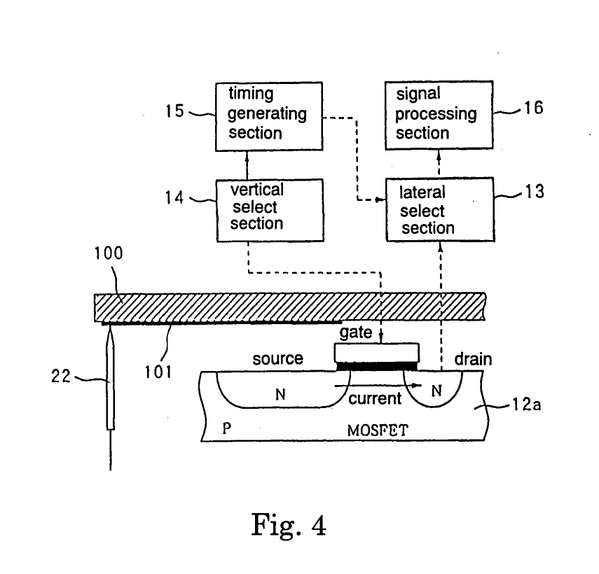

One specific example of the sensor chip 1 for use in the inspection system will be described below. FIG. 4 is an explanatory diagram of one of the sensor elements 12a composed of a semiconductor transistor.

The sensor element 12a is a MOS field effect transistor (MOSFET), in which one of diffusion layers is formed to have a lager surface area than that of the other diffusion layer. The diffusion layer having the larger surface area serves as a passive element, and this passive element is disposed in opposed relation to the circuit wiring 101. The passive element is formed continuously with a source of the MOSFET. The MOSFET also has a gate connected to the vertical select section 14, and a drain connected to the lateral select section 13. The diffusion layer serving as the passive element is also provided with a discharge potential barrier for discharging an unwanted charge.

When the sensor element 12a is selected by the timing generating section 15 through the vertical select section 14, a signal is transmitted from the vertical select section 14 to the gate to turn on the sensor element 12a (i.e. to bring the sensor element 12a into a state ready to output the detection signal).

At this moment, when a given voltage is applied to the circuit wiring 101 from the probe 22 as an inspection signal, the potential of the circuit wiring 101 is varied and thereby a current flows from the source to the drain. This current serves as the detection signal which is transmitted to the signal processing section 16 through the lateral select section 13. If no circuit wiring 101 exists at the position opposed to the sensor element 12a, no current will flow.

Thus, by analyzing the position of the sensor element 12a having the output current as the detection signal, it can be determined in what position of the circuit board 100 the circuit wiring 101 extending from its electrode in contact with the probe 22 is located.

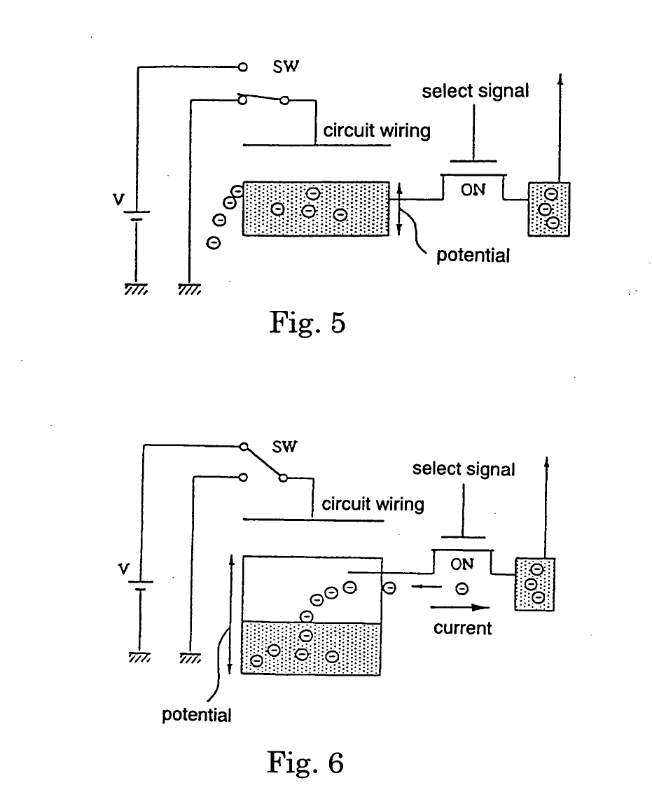

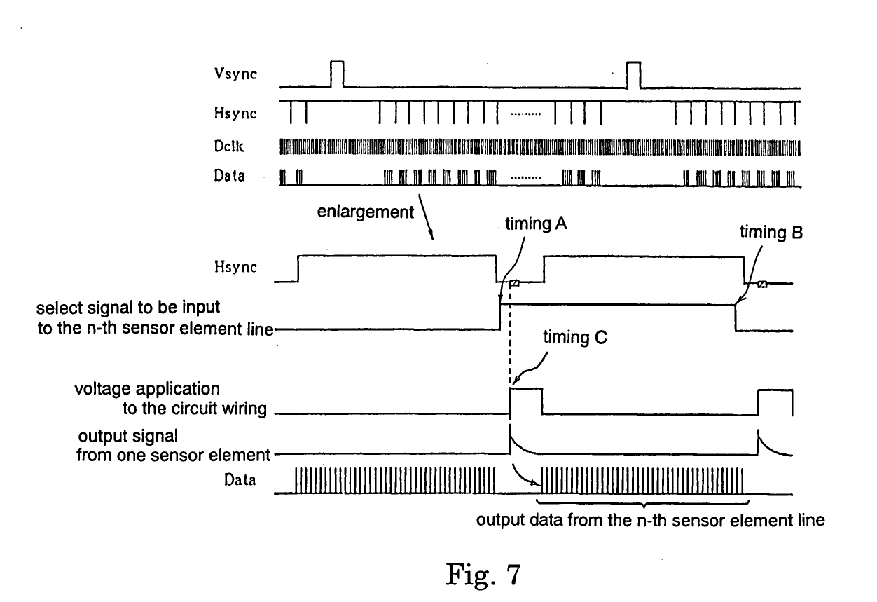

The principle of the current flow from the source to the drain will be described below in detail. FIGS. 5 and 6 are model diagrams for explaining this principle simply. FIG. 5 shows the state when no voltage is applied to the circuit wiring, and FIG. 6 shows the state when a given voltage is applied to the circuit wiring.

As shown in FIG. 5, if no voltage is applied to the circuit wiring, a surplus charge in the diffusion layer flows over from the discharge potential barrier having a lower potential than that of a potential barrier below the gate which is turned off. In this case, the potential of the source is defined by the potential of the discharge potential barrier.

As shown in FIG. 6, when a voltage V is applied to the circuit wiring, the circuit wiring is positively charged (at a potential V). Since the circuit wiring and the source-side diffusion layer are distanced at very close range, the source-side diffusion layer has the increased potential V by the influence of the potential variation in the circuit wiring, and thereby a charge flows into the source-side diffusion layer. That is, the source-side diffusion layer operates as if the circuit wiring and the source-side diffusion layer were capacitively coupled, so that the potential at the source-side diffusion layer is lowered to allow electrons to flow into the source-side diffusion layer or allow a current to flow from the source to the drain.

When the circuit wiring is connected to the ground again, the source-side diffusion layer gets back into the original potential, and thereby surplus electrons are released gradually from the discharge potential barrier.

<Signal Input/Output Timings in Sensor Chip>

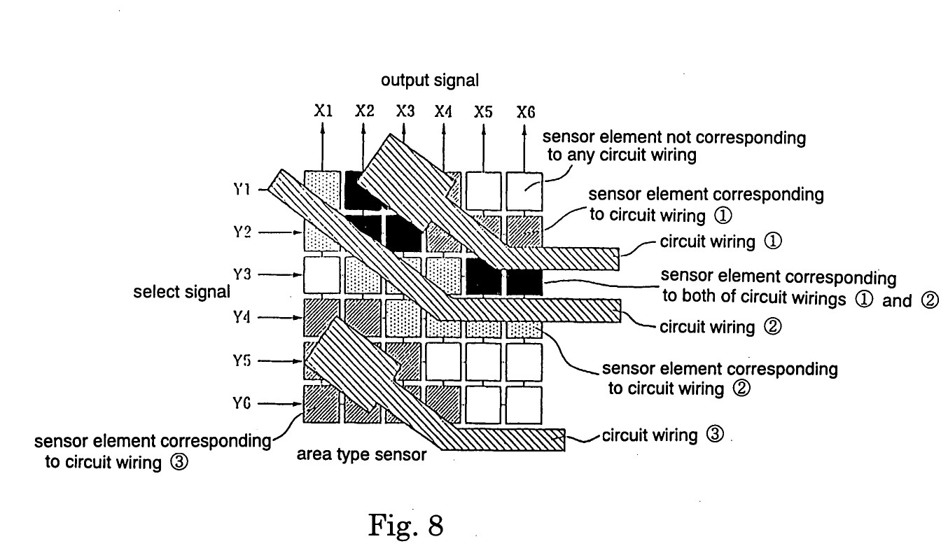

FIG. 7 is a timing chart showing input/output timings in the case of using a MOSFET as shown in FIG. 4.

The upper four lines show the Vsync, the Hsync, the Dclk and the output data from the sensor chip 1, respectively. The lower six lines show several enlarged Hsyncs and each of input/output signals in the sensor element generated during the course of these Hsyncs, respectively.

When the Vsync, Hsync and Dclk are input to the timing generating section 15 as shown in FIG. 7, the sensor chip 1 outputs data as shown by “DATA”.

More specifically, the timing generating section 15 starts counting the Dclk from the trailing edge of the n-th Hsync to control for the vertical select section 14 to transmit the selection signal to the n-th sensor-element line 12b at a given timing A. Then, the vertical select section 14 further counts the Dclk to keep transmitting the selection signal until a given timing B.

Concurrently, the computer 21 starts counting the Dclk from the trailing edge of the n-th Hsync to control for the selector 23 to apply the given voltage to the circuit wiring to be inspected, i.e. inspection circuit wiring, at a timing C which lies between the timings A and B.

The timing generating section 15 also controls for the lateral select section 13 to hold the detection signals from the n-th sensor-element line at the same timing as the timing C. The reason why this timing is set in the same as the timing C is that in case of using the MOSFET as shown in FIG. 4, the output from each of the sensor elements appears as an exponentially reducing current having a differential waveform of the voltage pulse applied to the circuit wiring.

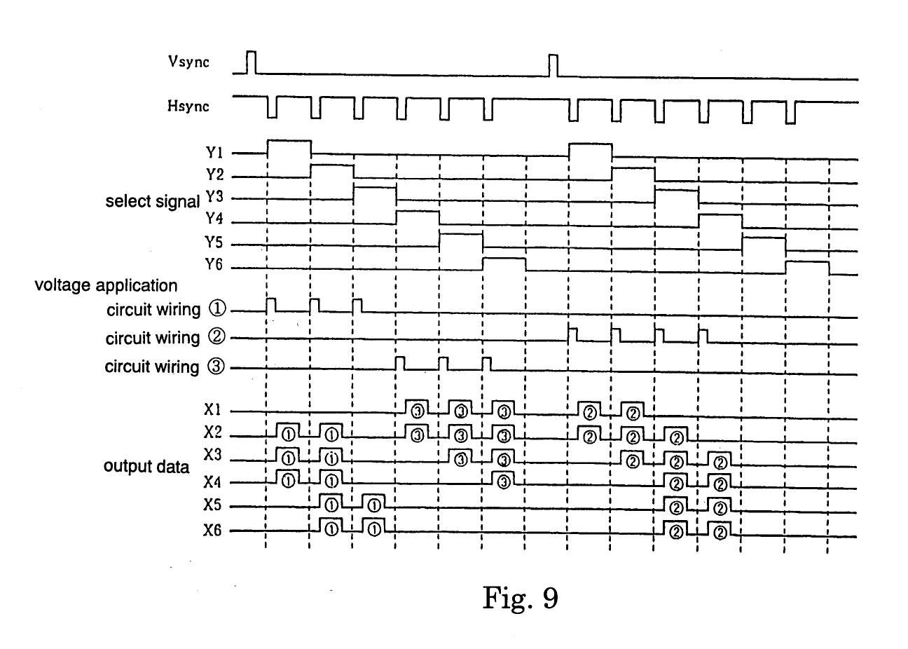

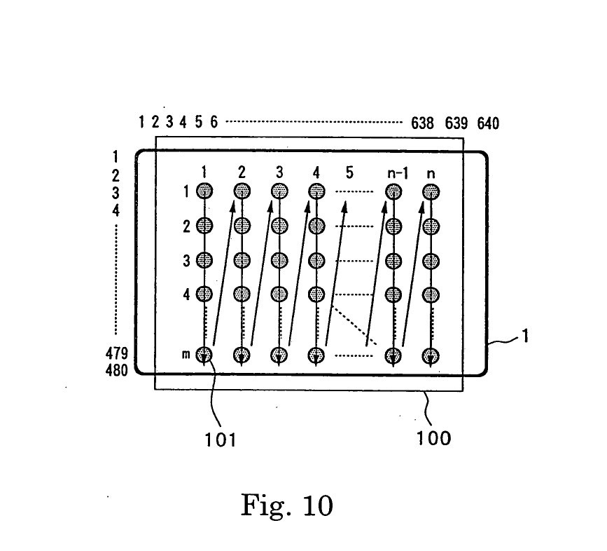

With reference to FIGS. 8 and 9, voltage application timings to three circuit wirings and corresponding output signals will be specifically described. FIG. 8 is an explanatory diagram of an inspection of the circuit wirings (1) to (3) by use of 6×6 sensor elements. FIG. 9 is an operational timing chart the inspection system. In the following example, data representing the shape of the circuit wiring (1), data representing the shape of the circuit wiring (3), and data representing the shape of the circuit wiring (2) are output in this order.

As the sensor elements corresponding to the circuit wiring (1), there are 10 sensor elements which are positioned at the coordinates (X2, Y1), (X3, Y1), (X4, Y1), (X2, Y2), (X3, Y2), (X4, Y2), (X5, Y2), (X6, Y2), (X5, Y3) and (X6, Y3).

As the sensor elements corresponding to the circuit wiring (2), there are 14 sensor elements which are positioned at the coordinates (X1, Y1), (X2, Y1), (X1, Y2), (X2, Y2), (X3, Y2), (X2, Y3), (X3, Y3), (X4, Y3), (X5, Y3), (X6, Y3), (X3, Y4), (X4, Y4), (X5, Y4), and (X6, Y4).

As the sensor elements corresponding to the circuit wiring (3), there are 9 sensor elements positioned at the coordinates (X1, Y4), (X2, Y4), (X1, Y5), (X2, Y5), (X3, Y5), (X1, Y6), (X2, Y6), (X3, Y6), and (X4, Y6).

Among these sensor elements, the 5 sensor elements at the coordinates (X2, Y1), (X2, Y2), (X3, Y2), (X5, Y3) and (X6, Y3) illustrated by black color are used for both inspections of the circuit wirings (1) and (2). Thus, both of the circuit wirings (1) and (2) cannot be inspected simultaneously by driving the sensor elements only one time. In addition, both of the circuit wirings (2) and (3) are inspected by using the sensor elements on the sensor-element line of the coordinate Y4. Thus, when using the above process in which one row of the sensor-element line is simultaneously driven, both of the circuit wirings (2) and (3) cannot be inspected simultaneously by driving the sensor elements only one time. In contrast, such a problem will not be caused between the circuit wirings (1) and (3).

Thus, both of the circuit wirings (1) and (3) is first inspected within the time period required for driving each of the sensor elements once (one frame), and then the circuit wiring (2) will be inspected in the subsequent frame.

Accordingly, as shown by the timing chart in FIG. 9, data representing the shape of the circuit wiring (1), data representing the shape of the circuit wiring (3), and data representing the shape of the circuit wiring (2) will be output sequentially.

<Process of Applying Voltage to Plural Circuit Wirings>

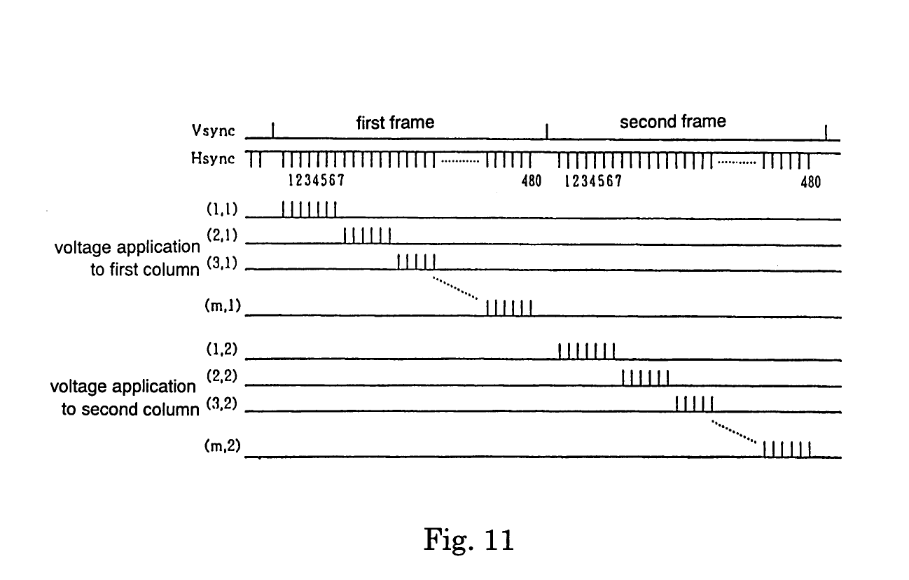

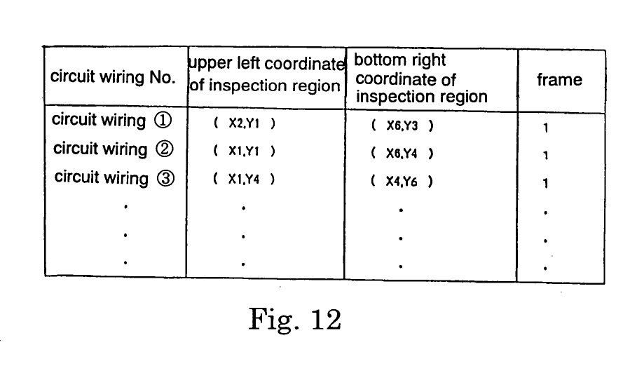

With reference to FIGS. 10 and 11, a process of efficiently applying voltage to a plurality of circuit wirings will be described below. FIG. 10 is an explanatory diagram of a sensor drive sequence (voltage supply sequence) to a plurality of circuit wirings formed on a single circuit board. FIG. 11 is a timing chart showing one example of voltage supply timings in the sensor drive control in FIG. 10.

For simplifying explanation, each of the target circuit wirings is indicated by ∘ in FIG. 10. The circuit wirings are generalized as a model arranged in a matrix form having m rows and n columns.

Fundamentally, during the time period of supplying voltage to one of the circuit wirings covered by the signal receiving region of the sensor, it is required to keep all of the remaining circuit wirings in a reference potential (GND). Because when the voltage is applied simultaneously to two target circuit wirings, there is a case where while one of the target circuit wirings includes a disconnection in the middle thereof, this circuit wiring with disconnection is short-circuited to the other target circuit wiring. In this case, the target circuit board will be improperly determined as an acceptable one, and the open or disconnection defect in the circuit wiring will be undesirably passed over.

A certain voltage is supplied to one of the circuit wirings once while driving one of the sensor-element lines. Thus, even if two or more of the circuit wirings are commonly covered by one of the sensor-element lines, the voltage can be applied to only one of the two or more circuit wirings

Thus, as illustrate, in the first frame, the voltage is applied to the circuit wirings aligned in the first column sequentially in the vertical direction from the upper side of the figure, or in order the first row, the second row, - - - , and the m-th row. In the second frame, the voltage is also applied to the circuit wirings arranged in the second column sequentially in the vertical direction from the upper side of the figure. Thus, in the n-th frame, all of the circuit wirings will be applied with the voltage.

Specific voltage supply timing is shown in FIG. 11. In response to each of the first Hsync to seventh Hsync in the first frame (in the interval from the first Vsync to second Vsync), the voltage is applied to the circuit wiring arranged in the first row and the first column or (1, 1).

Then, in response to each of the eighth Hsync to the fourteenth Hsync, the voltage is applied to the circuit wiring arranged in the second row and the first column or (2, 1). The voltage is further applied sequentially to the circuit wirings (3, 1), (4, 1), . . . , (m, 1). Then, shifting to the second frame, the voltage is applied sequentially to the circuit wirings (1, 2), (2, 2), . . . , (m, 2). Thus, the sensor elements are driven repeatedly until the entire circuit wirings are completely inspected, or until the inspection in the n-th-frame are completed.

<Modeling of Circuit Wirings>

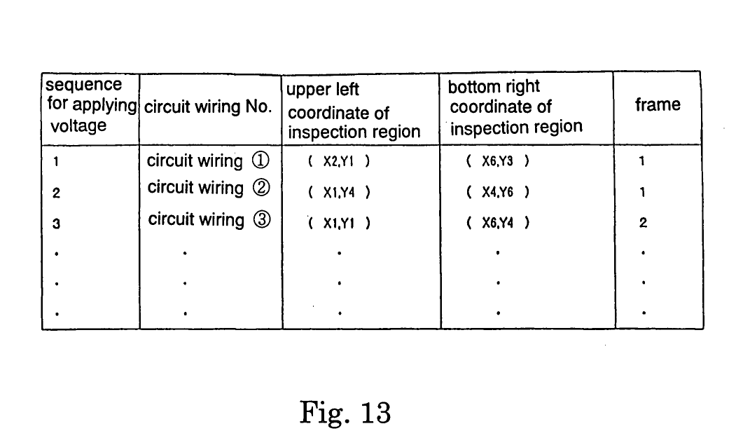

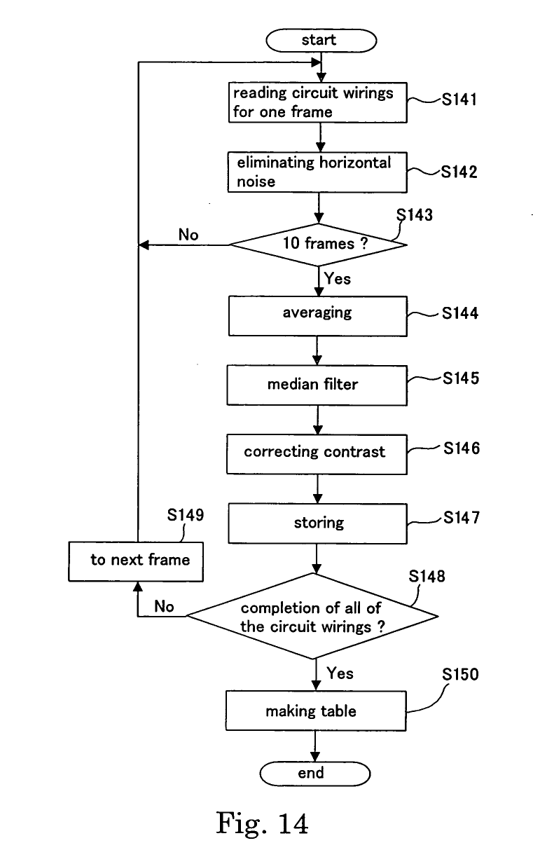

With reference to FIGS. 12 and 13, a process of modeling the circuit wirings in the matrix form, creating the standard-shape data, and registering in the HD 215 will be described below. In the first embodiment, the standard-shape data created through this process is used to inspect the circuit wirings.

A region of the inspection circuit wiring is cut out in a rectangular shape from the design data (e.g. CAD data) representing the shape of the circuit wirings to produce a table as shown in FIG. 12. In FIG. 12, each of the individual circuit wirings is uniquely numbered, and the uppermost and leftmost coordinate and the bottommost and rightmost coordinate of the rectangular region including each of the numbered circuit wirings are associated with the coordinates of the sensor element to indicate them on this table. The first frame is first selected for all of the numbered circuit wirings.

Then, the numbered circuit wirings are rearranged in order of smaller value in the upper left Y-coordinate. In FIG. 12, the first is the circuit wirings (1) and (2) each having the Y-coordinate Y1, and the second is the circuit wiring (3) having the Y-coordinate Y4.

Then, the upper left Y-coordinate value of each of the numbered circuit wirings is compared with the bottom right Y-coordinate value of each immediately preceding circuit wiring. When the former is smaller than the latter, the frame of the former is shifted to another one on the assumption that the sensor-element lines for reading these circuit wirings are overlapping.

In FIG. 12, the circuit wiring (1) is defined as a circuit wiring to which the voltage is first applied. Then, the upper left Y-coordinate of the circuit wiring (2) is compared with the bottom right Y-coordinate of the circuit wiring (1). In this case, the circuit wiring (1) is Y3, and the circuit wiring (2) is Y1, wherein Y3 is larger than Y1. Thus, the circuit wiring (2) is shifted to the second frame. Since the second frame is inspected after the first frame, the circuit wiring (2) is transferred to the lowest line of the table.

At this moment, the circuit wiring immediately preceding to the circuit wiring (3) is the circuit wiring (1). Then, the upper left Y-coordinate Y4 of the circuit wiring (3) is compared with the bottom right Y-coordinate Y3 of the circuit wiring (1). Since Y4 is greater than Y3, the circuit wiring (3) remains in the first frame. Repeating the same steps, each frame for the circuit wiring (4), and all other circuit wirings will be defined as either one of the first and second frames. Through the above steps, each of the circuit wirings is grouped into either one of the first frame and the second frame.

The same steps are carried out in the group of the second frame. In this case, the upper left Y-coordinate value of the circuit wiring is compared with the bottom right Y-coordinate value of the immediately preceding circuit wiring to which the voltage is applied. Then, when the former is less than the latter, the circuit wiring having the less value is shifted to the third frame. If NO, the circuit wiring having the greater value is left in the second frame.

Through the above steps, the first, second and third frames are grouped. These steps are carried out as long as additional frame is required. When no additional frame is required, this process will be terminated.

As a result of the above process, the table as shown in FIG. 13 is produced. In this table, the frame numbers correspond to the column numbers shown in FIG. 10, and the numbers representing the sequence for applying a voltage to the circuit wirings within the same frame correspond to the row numbers shown in FIG. 10.

Referring to FIG. 13, in response to the first to third Hsyncs (see Y-coordinate) after the first Vsync, a voltage pulse is first applied to the circuit wiring (1), and then in response to the fourth to sixth Hsyncs, a voltage pulse is applied to the circuit wiring (3). Further, in response to the first to fourth Hsyncs after the second Vsync, a voltage pulse is applied to the circuit wiring (2).

In the above process, on the assumption that the design data on the shape of the circuit wirings completely corresponds to the coordinates of the sensor elements, the profile coordinates of the circuit wiring is simply defined as the coordinates of the sensor elements. However, some displacement is actually caused by mechanical superposition between the sensor and the circuit wiring. Thus, the above Y-coordinate for determining the region to be inspected may be set to provide a slightly wider region in consideration with the above displacement.

<Process for Image Processing>

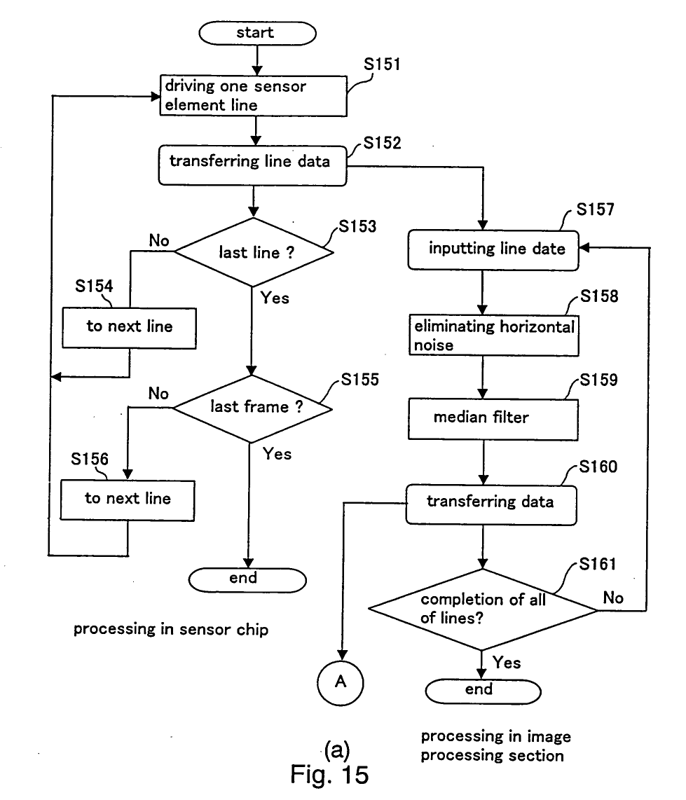

With reference to FIG. 14, a processing for extracting reference data to be performed before the initiation of an actual inspection in the inspection system will be described below. FIG. 14 is an explanatory flow chart of a processing for detecting the shape of circuit wirings formed on a gold sample (standard circuit board) to extract standard-shape data (standard pattern of potential variation) as reference data.

At Step S141, a plurality of circuit wirings on the gold sample (standard circuit board) are inspected for one frame. Specifically, all of sensor elements are driven to create digital data representing the shape of the circuit wirings which can be made in a model arranged in one column.

At Step S142, horizontal noise is eliminated. In this step, the data corresponding to 10 dots on the left edge of the created image are horizontally averaged, and the average value is subtracted from the value of the original entire image data.

At Step S143, it is determined whether the readout for 10 frames has been completed. If NO, the process returns to Step S141 to repeat the circuit-wiring inspection.

If the inspection for 10 frames is completed at Step 143, the process will advance to Step S144. At Step S144, the image data for 10 frames are averaged. Then, at Step S145, the averaged data is passed through a median filter. By this processing, local noise is eliminated.

Then, after correcting contrast at Step S146, profile data subjected to an image processing at Step S147 is stored in the RAM 214 of the computer 21 as reference data.

At step S148, it is determined whether digital data for all of the circuit wirings on the gold sample have been extracted. If digital data for all of the circuit wirings are not fully extracted, and some un-inspected circuit wirings remain, the process will advance to Step S149.

At Step 149, the current frame is shifted to the next frame to allow data on the un-inspected circuit wirings to be extracted. Then, the process returns to Step 141. The processing from Step S141 to Step S147 will be carried out in the next frame.

By repeating the processing from Step S141 to Step S147, the extraction of the image data for all of the circuit wirings will be completed. The completion of the extraction of the image data for all of the circuit wirings is determined at Step 148, and then the process advances to Step S150 to create a standard-image table. This standard-image table shows the correlation between each of the circuit wirings and the range/the gradation thereof. After producing the standard-image table, the processing for extracting the reference data is completed.

Through the above processing, standard-image data as criteria for inspection can be created. The standard-image data as criteria will be compared with actual-image data on a target circuit wiring to be detected by the sensor elements in a subsequent inspection process to achieve highly reliable circuit-wiring inspection unsusceptible to the variation and aged-deterioration in sensitivity of the sensor elements.

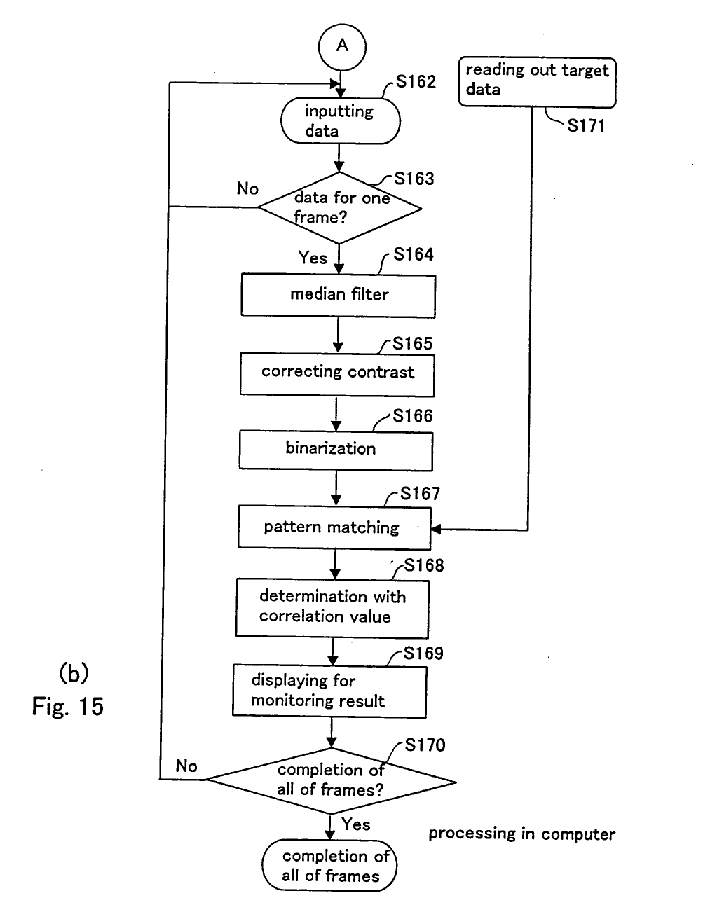

With reference to FIG. 15, an actual inspection control in the inspection system will be described blow. FIG. 15 is an explanatory flowchart of an inspection control in the inspection system.

In the first embodiment, before initiating a processing of inspecting circuit wirings on a circuit board, the sensor chip 1 is located at an initial inspection position of the circuit board, and the probe 22 for supply an inspection signal is brought into contact with one of the ends of a first target circuit wiring 101. The inspection signal is then supplied to the first target circuit wiring through the probe 22, and the remaining or adjacent circuit wirings are controlled to be at ground level. Then, the following inspection processing will be performed.

At Step S151, the sensor elements in each of the sensor-element lines are driven. Then, at Step S152, obtained digital data for each of the sensor-element lines is transmitted to the image-processing section 213 of the computer.

At Step S153, it is determined whether the sensor-element line associated with the transmitted data is the last sensor-element line in one frame covering the target circuit wirings. If NO, the process will advances to a processing for the next sensor-element line.

When it is determined at Step S153 that the sensor-element line associated with the transmitted data is the last sensor-element line in the frame covering the target circuit wirings, the process advances to Step S155, and it is checked whether the processing on the computer is completed. If NO, the process waits until the computer completes the processing. Because the data must be finally received and processed by the computer.

When it is determined at Step S155 that the computer processing has been completed, the process advances to Step S144, and a processing for the next circuit wiring is performed.

In the system according to the first embodiment, the image-processing section is operable to enter the digital data for one sensor-element line to the computer 21 as shown in Step S157, in response to the line data transmission from the sensor chip 1 as shown in Step S152, and then horizontal noises are eliminated at Step S156.

While this process is similar to that in Step S142 in FIG. 14, it performs a median filter processing using a median filter at Step S159 after eliminating the noise without the averaging processing for 10 frames as in Steps S143 and S144.

Then, at Step S160, the processed digital data is transmitted to and stored in the RAM 214 of the computer 21.

At Step S161, it is determined whether data on all of the sensor-element lines in the entire frame have been stored in the RAM 214. If data of the sensor-element lines corresponding to the target circuit wirings (required lines) have not been transmitted, the process returns to Step S157, and repeats Steps S157 to S161.

Otherwise, if it is determined at Step S161 that the processing of the sensor-element lines corresponding to the target circuit wirings (required lines) have been completed, the operation in the image-processing section 213 is terminated.

When the computer 21 receives from the image-processing section 213 data corresponding to the processing at Step S160, it performs a processing at Step S 162 and subsequent steps to determine the acceptability of the target circuit wiring in accordance with the detected potential variation in the target circuit wiring and create an image of the shape of the target circuit wiring to allow the shape of the target circuit wiring to be visually checked.

Specifically, at Step S162, the processed data from the image-processing section 213 are entered and stored in the RAM 214. Then, at Step S163, it is determined whether the data for one frame has been stored in the RAM 214. If NO, the data input processing at Step S162 will continue.

When it is determined at Step S163 that the data for one frame has been stored, the process advances to Step S164, and the entire stored image data is subjected to a median filter processing using a median filter.

At Step S165, the filtered data is corrected in contrast. Then, at Step S166, the data is binarized, and then the profile of the subject is traced.

The process advances to Step S167, and the obtained image data are compared with reference data, which is obtained by the processing as shown in FIG. 14, through a least squares method. More specifically, actual-shape data of the target circuit wiring created in accordance with positional information from the sensor elements which have detected potential variation generated in the target circuit wiring in response to an inspection signal supplied to the target circuit wiring is compared with the corresponding standard-shape data in the standard-circuit-wiring data registered, for example, in the HD 215, through the processing in FIG. 14.

Then, the process advances to Step S168. At Step S168, the correlation value between the above two data is determined to inspect the state of the target circuit wiring. As above, the standard-shape data is created using the same sensor elements as those used in an actual inspection. Thus, even if the sensor elements have variation, aged-deterioration and/or local malfunction, resulting adverse affects can be minimized to maintain highly reliable inspection.

Then, at Step S169, the comparison result is displayed on the display 21a in such a manner that the difference between the image data and the reference data can be visibly recognized. This allows an operator to visually check the state of the target circuit wirings in the frame.

At Step S170, it is determined whether the processing for required frame has been completed. If NO, the process returns to Step S162, and the above processing will be repeated until the results of the required frame is completely displayed, to compare between the reference data and the image data for the entire frame related to the target circuit wirings, and display the comparison result.

Otherwise, when it is determined at Step S170 that the processing for required frame has been completed, the inspection for one circuit board is completed.

Considering that the profile tracing is required to take time, actual field-emission image data may be simply compared with standard field-emission image data as the reference data. In this case, the criterion of the acceptability may be arranged such that the actual-image data is determined as acceptable if the difference between the respective the tone values (gradation values) of the actual and standard image data falls within +given gradations.

While the sensor elements 12a in the sensor chip 1 is two-dimensionally arranged in conformity with the shape of the circuit board 100, they may be three-dimensionally arranged.

Preferably, the sensor elements 12a have a uniform shape as shown in FIG. 3. This is intended to allow the respective sensor elements 12a to supply the inspection signal to the circuit wiring and receive the signal generated in the circuit wiring, without any deviation.

As shown in FIG. 3, the sensor elements 12a is preferably arranged in the row and column directions at even intervals or in a matrix arrangement. This makes it possible to reduce the unevenness in the number of the sensor elements 12a per a unit area opposed to the circuit wirings and to clarify the positional relationship between the sensor elements 12a so as to readily specify the shape of the circuit wiring based on the detection signals. Depending on the shape of a target circuit wiring, the sensor elements may also be arranged only in a single line.

While the sensor elements 12a in the sensor chip 1 are arranged in 480 rows×640 columns, this has been expediently selected for this embodiment, and 200,000 to 2,000,000 of sensor elements may be arranged in an area of 5 to 50 μm². In order to achieve an accurate inspection, it is preferable to set the interval or pitch of sensor elements 12a in conformity with the line width of a circuit wiring.

While N-channel MOSFET is used as the sensor element herein, the present invention is not limited thereto, but P-channel MOSFET may also be used. Further, while the passive element is formed as the n-type diffusion layer, the present invention is not limited thereto, but any other suitable material having relatively high conductivity, such as amorphous semiconductors, may be used. Furthermore, a conductor plate may be in ohmic contact with the surface of the source-side diffusion layer serving as the passive element. Thus, the electrical conductivity of the surface of the passive element can be increased, or a signal charge can be concentrated in the vicinity of the surface of the passive element to provide increased density of the signal charge, and enhanced capacitive coupling. In this case, the conductor plate may be formed of a metallic film or a polycrystalline semiconductor.

The sensor element may be a charge-voltage conversion circuit in which a diffusion layer of the semiconductor serves as an element for receiving signals from a circuit wiring. In this case, the detection signal may be picked up in the form of an amplified voltage so as to discriminate the detection signal more clearly. This allows the inspection of the circuit board to be performed with a higher degree of accuracy. A Bipolar transistor may also be used as the sensor element to output the detection signals accurately at a high speed. A thin-film transistor, such as TFT, may also be used as the sensor element to provide enhanced productivity of the sensor element and increased array area of the sensor elements.

Additionally, a charge transfer element may be used as the sensor element. The charge transfer element may include a CCD. In this case, a charge-readout MOSFET may be used as the transistor. Then, the passive element may be formed continuously with a diffusion layer serving as a source of the charge-readout MOSFET, and the selection signal may be input into a gate of the charge-readout MOSFET to reduce a potential barrier formed below the gate. Further, a signal charge residing in the source may be transferred to a drain of the charge-readout MOSFET as a charge for the detection signal, and then the detection signal may be transferred by the charge-transfer element connected to the drain.

Furthermore, a charge-supply MOSFET for supplying a charge to the passive element in response to the potential variation in the conductive pattern and forming a potential barrier not to cause the backflow of the supplied charge before completing the potential variation in the conductive pattern may be provided, and a drain of the charge-supply MOSFET may be formed continuously with the diffusion layer serving as the passive element to provide a stable charge transfer. Using the charge-transfer element will also eliminate the need for providing a switching circuit, such as a multiplexer, to the lateral select section.

The sensor elements may be provided on a board of any material other than conductive materials, such as glass, ceramics, glass epoxy or plastics, and formed of any material capable of receiving electromagnetic waves radiated from the circuit wiring applied with the inspection signal, such as a material having a relatively high conductivity, metallic film, polycrystalline semiconductor, or an amorphous semiconductor.

While the first embodiment is arranged to detect the voltage variation in the circuit board, it may also be arranged to detect the magnitude of the electromagnetic waves radiated from the circuit wiring and the radiation shape thereof. If a given magnitude and shape of the electromagnetic waves are detected, it will be determined that the continuity of the circuit wiring is normally. If a lower magnitude and a different shape of the electromagnetic waves with respect to a given criterion are detected, it will be determined that the circuit wiring has some disconnected portion or chipped portion.

Further, while the first embodiment is arranged to bring the probe into contact with the end of the circuit wiring, a non-contact terminal may also be used to input the inspection signal from the starting point of the circuit wiring. The sensor chip may be a line-type sensor in which the sensor elements are arranged in one line. In this case, a given region of the circuit wirings may be inspected by moving the sensor chip vertically. When the inspected circuit wirings on the circuit board are larger than the array of the sensor elements, an area-type sensor may also be used and mechanically moved.

If the shape of the circuit wirings is considerably run off the edge of the signal receiving region of the sensor, each data received at different positions of the sensor elements may be saved and then combined.

While the first embodiment is arranged to simultaneously drive one sensor-element line, the present invention is not limited to this manner, and a plurality of sensor-element lines or a plurality of sensor elements in an area shape or non-line shape may be simultaneously driven. In such cases, if a plurality of sensor element groups opposing to the shape of the inspection circuit wiring are overlapped with a part of the sensor element groups opposing to the shape of another circuit wiring, the timing for applying a voltage to said another circuit wiring is also set in a selected period in a different frame.

As described above, according to the first embodiment, the standard-shape data or standard-image data as criterion are created using the same sensor elements as those used in an actual inspection. Thus, even if the sensor elements have variation, aged-deterioration and/or local malfunction, resulting adverse affects can be cancelled out or minimized to provide a highly reliable inspection system.

[Second Embodiment]

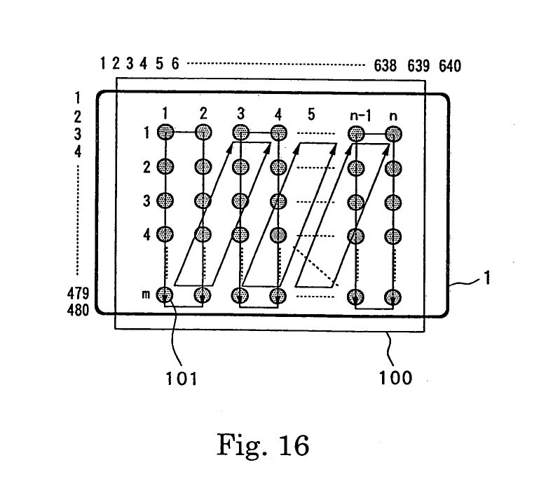

With reference to FIGS. 16, 17 and 18, an inspection system as a second embodiment of the present invention will now be described. The inspection system of the second embodiment is different from the first embodiment in that two adjacent circuit-wiring lines are inspected simultaneously within one frame. Other points are the same as those of the first embodiment. Thus, in FIGS. 16 to 18, the same components will be defined by the same reference numerals, and their description will be omitted.

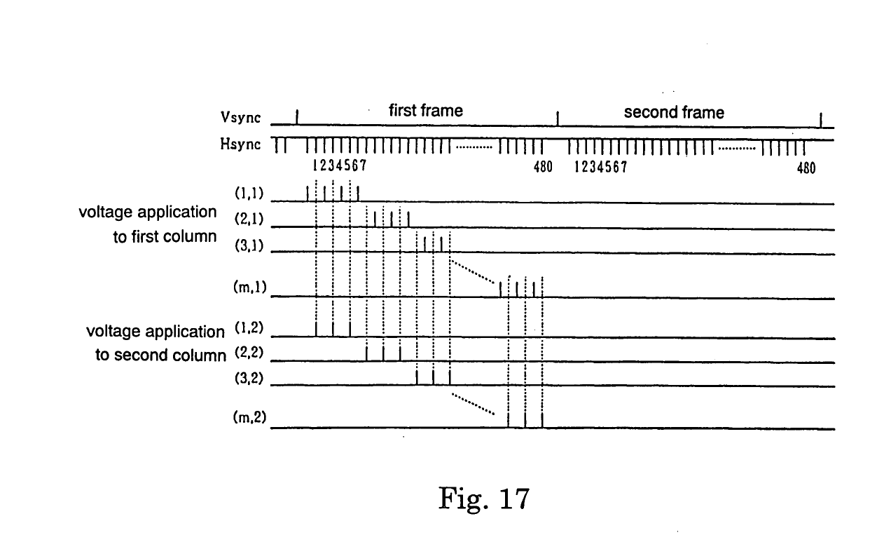

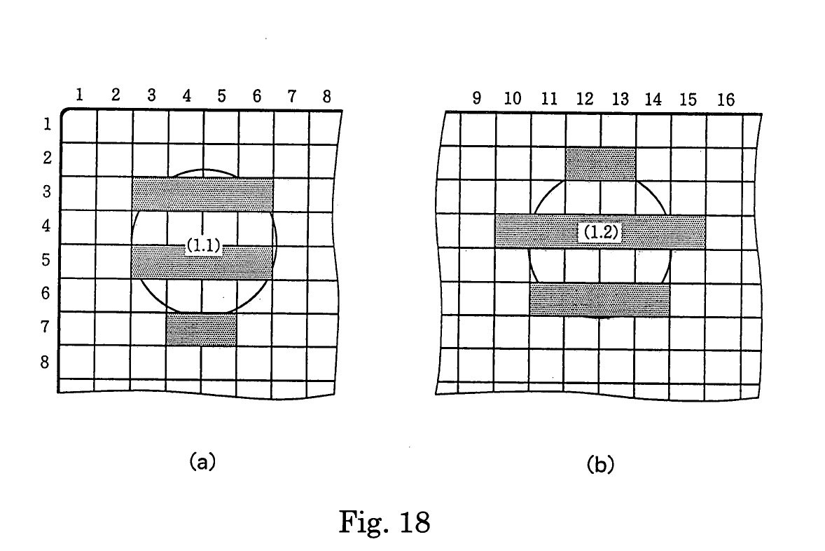

FIG. 16 is an explanatory diagram of a voltage supply sequence to a plurality of circuit wirings formed on a circuit board. FIG. 17 is a timing chart showing an example of the voltage supply timing to the circuit wirings shown in FIG. 16. FIG. 18 is a diagram showing an output image obtained when a voltage is supplied at the timing in FIG. 17.

In FIG. 16, for simplifying the description as with FIG. 10, the inspection circuit wirings are indicated by ∘ and arranged in a matrix form of m rows×n columns.

As shown in the FIG. 16, according to the second embodiment, in the first frame, the voltage is applied to the circuit wirings aligned in the first and second columns sequentially in the vertical direction of the Figure from above, or in order the first row, the second row, - - - , and the m-th row. In the second frame, the voltage is also applied to the circuit wirings arranged in the third and fourth columns sequentially in the vertical direction of the Figure from above. Thus, in the n/2-th frame, all of the circuit wirings will be applied with the voltage.

FIG. 17 is a timing chart showing an example of the timing for applying the voltage to the circuit wirings shown in FIG. 16.

As shown in this FIG. 17, in response to each of the first, third, fifth and seventh Hsyncs in the first frame (in the interval from the first Vsync to second Vsync), the voltage is applied to the circuit wiring arranged in the first row and the first column or (1, 1).

Then, in response to each of the second, fourth, sixth and eighth Hsyncs, the voltage is applied to the circuit wiring arranged in the first row and the second column or (1, 2). Then, in response to each of the ninth, eleventh, - - - Hsyncs, the voltage is applied to the circuit wiring arranged in the first column, and then in response to each of the tenth, twelfth, - - - Hsyncs, the voltage is applied to the circuit wiring arranged in the second column (1, 2).

In the same manner, the voltage is applied in the second and succeeding frames. Specifically, the voltage is applied to the circuit wirings in the odd columns in response to the odd Hsyncs, and the voltage is applied to the circuit wirings in the even columns in response to the even Hsyncs.

That is, the timing for inputting the selection signal, the timing for detecting the voltage variation from the sensor-element line, and the timing for supplying the inspection signal to the circuit wirings are controlled to drive the sensor elements in the odd lines so as to detect the circuit wirings in the first column and to drive the sensor elements in the even lines so as to detect the circuit wirings in the second column.

In other words, the timing for applying the voltage to one circuit wiring is provided to skip over one sensor-element line, or at the interval of one sensor-element line. The image data will appears by skipping over one sensor-element line.

As a result, the image for each of the circuit wirings in the odd columns is displayed only by the odd sensor-element lines (FIG. 18(a)), and the image for each the circuit wirings in the even columns is displayed only by the even sensor-element lines (FIG. 18(b)).

In this manner, by applying the voltage alternately to the circuit wirings in the odd columns and the circuit wirings in the even columns in a same frame, the inspection time can be shortened half. The profile of the entire circuit wiring can be obtained by processing the image data and interpolating vacant lines.

Further, depending on the resolution of the sensor elements, the inspection of the circuit wirings in the plural columns may be performed within one frame period. For example, when the inspecting of the circuit wirings in five columns is performed within one frame period, the voltage may be applied to the same circuit wiring at every 5 Hsyncs.

[Third Embodiment]

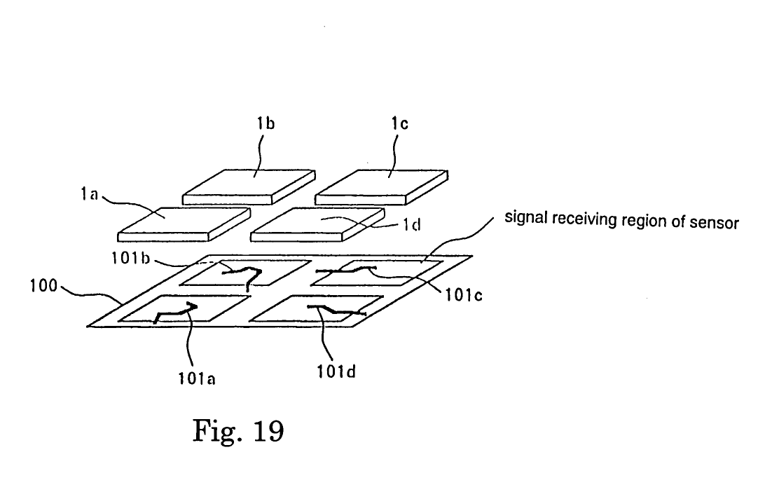

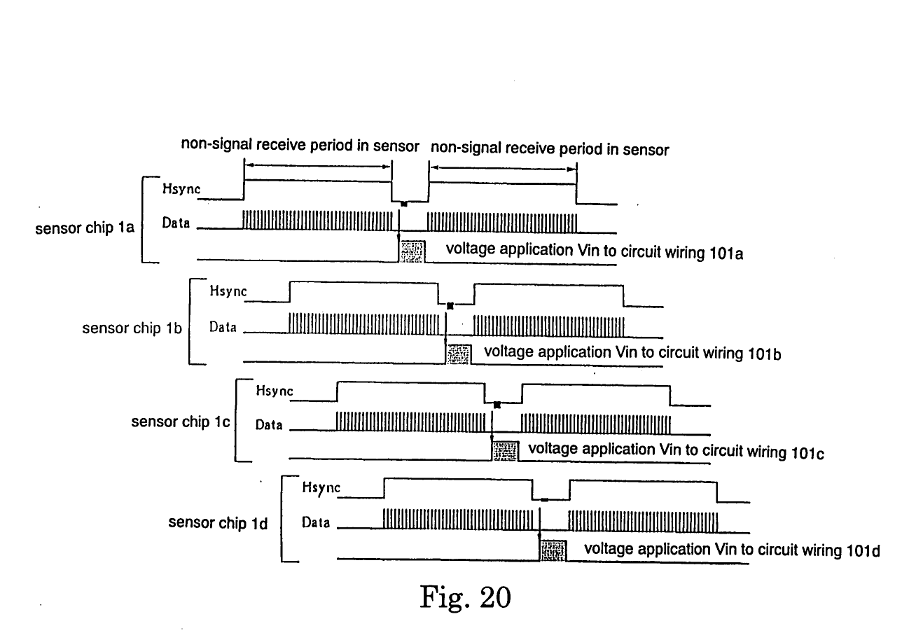

With reference to FIGS. 19 and 20, an inspection system as a third embodiment of the present invention will now be described. FIG. 19 is an explanatory diagram of a drive control of censor chips in the inspection system according to the third embodiment. FIG. 20 is a timing chart showing the drive timing of the sensor chips and the voltage supply timing to circuit wirings in the inspection system according to the third embodiment.

As shown in FIG. 20, the inspection system according to the third embodiment is characterized in that four sensor chips are simultaneously driven to a single circuit board. Other construction is the same as that in the first embodiment, and thus its description will be omitted.

In this inspection system, if a circuit board has a size greater than that of the receiving region of one of the sensor chips, the four sensor chips will be simultaneously driven to reduce an inspection time.

A simple solution of entering a common Hsync signal in phase into the four sensor chips is conceivable to simultaneously drive the four sensor chips.

However, considering that a voltage cannot be supplied simultaneously to a plurality of circuit wirings, it is desired to select one of the sensor chips 1a, 1b, 1c and 1d in this order and sequentially inspect the respective regions corresponding to the sensor chips. In this case, given that there are circuit wirings requiring n frames with respect to each of the sensor chips, an inspection time for 4n frames is required.

As shown in the timing chart illustrated in FIG. 20, in the inspection system according to the third embodiment, Hsync signals for the four sensor chips are dephased, and a voltage is supplied to four of the circuit wirings within the period of one frame. This control utilizes the fact that even if a voltage is applied to the plurality of circuit wirings except for the period when data is read from the horizontal sensor-element line, an output image of one of the circuit wirings will not be affected by the remaining circuit wirings.

Specifically, the respective timings of supplying a voltage to the four circuit wirings are sifted to prevent them from overlapping with each other, and correspondingly the Hsync signals for the four sensor chips are dephased. According to this method, a plurality of circuit wirings can be inspected within one frame as long as a voltage is not applied simultaneously to two or more of the circuit wirings.

Thus, the inspection time can be reduced ¼ as compared to the case where in-phase synchronization signals are applied to four sensor chips.

### INDUSTRIAL APPLICABILITY

As mentioned above, the present invention can provide an inspection apparatus and method capable of inspecting a circuit wiring with high reliability irrespective of the variation and aged-deterioration in sensor elements.

1. An inspection apparatus for inspecting selected at least one of a plurality of circuit wirings formed on a circuit board, comprising:
supply means for supplying an inspection signal to said selected circuit wiring;
detecting means including a plurality of sensor elements to detect potential variation generated in said selected circuit wiring in response to said inspection signal;
standard-pattern registration means for creating standard-image data representing the shape of a standard circuit wiring formed on a standard circuit board, in accordance with positional information from one or more of said sensor elements which have detected potential variation generated in said standard circuit wiring in response to said inspection signal supplied from said supply means to said standard circuit wiring, and then registering said created standard-image data therein;
actual-image data creation means for creating actual-image data representing the shape of said selected circuit wiring, in accordance with positional information from the sensor elements which have detected potential variation generated in said selected circuit wiring in response to said inspection signal supplied from said supply means to said selected circuit wiring; and
inspection means for comparting between said actual-image data created by said actual-image creation means and the corresponding standard-image data registered in said standard-image registration means, to inspect said selected circuit wiring.

2. The inspection apparatus as defined in claim 1, wherein said standard-pattern registration means is operable to create and register said standard-image data representing the entire shape of said standard circuit wiring, and said inspection means is operable to specify a certain region of the circuit wiring to be supplied with said inspection signal, in accordance with design data on the shape of said circuit wiring and compare the standard-image data corresponding to said specified region with the actual-image data obtained from said specified region of said circuit wiring.

3. The inspection apparatus as defined in claim 1 or 2, wherein said supply means is operable to supply said inspection signal to each of said circuit wirings at a different timing.

4. The inspection apparatus as defined in claim 1 or 2, wherein said sensor elements are formed in a matrix arrangement having a plurality of horizontal sensor-element lines each including two or more of said sensor elements,
wherein said supply means is operable to supply a selection signal simultaneously to all of the sensor elements in one of said sensor-element lines, and
said detecting means is operable to simultaneously detect potential variation in the circuit wiring opposed to said sensor-element line.

5. A method for inspecting selected at least one of a plurality of circuit wirings formed on a circuit board, comprising the steps of:
providing supply means for supplying an inspection signal to said selected circuit wiring, detecting means including a plurality of sensor elements to detect potential variation generated in said selected circuit wiring in response to said inspection signal;
creating standard-image data representing the shape of a standard circuit wiring formed on a standard circuit board, in accordance with positional information from one or more of said sensor elements which have detected potential variation generated in said standard circuit wiring in response to said inspection signal supplied from said supply means to said standard circuit wiring, and then registering said created standard-image data;
creating actual-image data representing the shape of said selected circuit wiring, in accordance with positional information from the sensor elements which have detected potential variation generated in said selected circuit wiring in response to said inspection signal supplied from said supply means to said selected circuit wiring; and
comparting between said created actual-image data and the corresponding registered standard-image data, to inspect said selected circuit wiring.

6. The method as defined in claim 5, wherein:
said standard-image creating step includes creating and registering standard-image data representing the entire shape of said standard circuit wiring; and
said comparing step includes specifying a certain region of the circuit wiring to be supplied with said inspection signal, in accordance with design data on the shape of said circuit wiring, and comparing the standard-image data corresponding to said specified region with the actual-image data obtained from said specified region of said circuit wiring.

7. The method as defined in claim 5 or 6, wherein said supply means is operable to supply said inspection signal to each of said circuit wirings at a different timing.

8. The method as defined in claim 5 or 6, wherein said sensor elements are formed in a matrix arrangement having a plurality of horizontal sensor-element lines each including two or more of said sensor elements,
wherein said supply means is operable to supply a selection signal simultaneously to all of the sensor elements in one of said sensor-element lines, and
said detecting means is operable to simultaneously detect potential variation in the circuit wiring opposed to said sensor-element line.

9. A computer-readable recording medium storing thereon a computer program for achieving the method as defined in claim 5 or 6, according to computer control.

10. A program sequence for achieving the method as defined in claim 5 or 6, according to computer control.
